(19) United States
(12) Patent Application Publication
(10) Pub. No.: US 2025/0277728 A1
(43) Pub. Date: Sep. 4, 2025

(54) SYSTEMS AND METHODS FOR MULTI-ANGLE DETECTION OF DYNAMIC LIGHT SCATTERING

(71) Applicant: Trinean NV, Gent (BE)

(72) Inventors: Tom J. BOONEFAES, Gent (BE); Pieter Alfons J. TORFS, Sint Amandsberg (BE)

(21) Appl. No.: 19/012,084

(22) Filed: Jan. 7, 2025

Related U.S. Application Data
(60) Provisional application No. 63/618,653, filed on Jan. 8, 2024.

(51) Int. Cl. G01N 15/0205

(52) U.S. Cl. CPC G01N 15/0211

(57) ABSTRACT

Described herein are systems and methods that obtain dynamic light scattering data from a plurality of particle samples, and in some instances, also measure the UV/Vis absorption spectrum of the particle samples. The systems and methods may characterize particles in the samples by obtaining light scattering data from multiple angles by a single rotating light detector. The data obtained in this manner may allow a greater dynamic range of particle sizing than when using a single angle.

### CROSS-REFERENCE TO RELATED APPLICATIONS

This application claims priority to U.S. Provisional Application No. 63/618,653, filed on Jan. 8, 2024, which is hereby incorporated by reference in its entirety.

### FIELD

This application relates to systems and methods for characterizing particles, e.g., nanoparticles, DNA, RNA, viruses, proteins, polymers, and/or small molecules. The characterization may include obtaining light scattering and/or UV/Vis data relating to the particles. When light scattering data is obtained, it may be detected using a rotating detector capable of measuring scattered light at multiple angles.

### BACKGROUND

Dynamic light scattering is a generally known method for analyzing particles in which measurements of scattered light over time are used to determine a size or size distribution of particles. Particle characteristics may be inferred from the temporal variation in the scattered light. For example, an autocorrelation may be performed on the time series of scattered light intensity, followed by a fit (e.g. Cumulants, CONTIN, NNLS/non-negative least squares) to the autocorrelation function to determine particle characteristics. In other instances, a Fourier transform may be used to determine a power spectrum of the scattered light, and an analogous fit to the power spectrum performed to determine particle characteristics.

Typically, light scattered in a single, well-defined angle is used when making a dynamic light scattering measurement. However, the direction and the number of photons scattered depends on the size of the particle. For example, if the particle is small, light may be scattered quite uniformly in all directions. If the particle is large, more light may be scattered in the forward direction than the backward direction. Thus, when analyzing a mixture of particle sizes (e.g., some small and some large), the light scattering results may be misrepresented when measured at a single angle, or some particles may not be seen at all because each particle size produces a unique scattering pattern. Put another way, the results relating to the particles may differ depending on which angle is being used to detect the scattered light.

Accordingly, detecting light scattered at more than one angle has been developed to obtain a dynamic light scattering measurement for samples. Some conventional systems obtain multi-angle measurements by positioning multiple light detectors or multiple light emitters around a single sample of interest. However, these systems have several drawbacks, including, e.g., a limited range of detection angles for the scattered light and/or time consuming processing of results because information between multiple light detectors and multiple light emitters must be matched.

Thus, there is a need for new and useful systems for detecting scattered light at multiple angles. Methods for determining particle size and/or particle size distribution in a sample may also be useful.

### SUMMARY

Described herein are systems and methods that obtain dynamic light scattering data from particle samples, and in some instances, also measure the UV/Vis absorption spectrum of the particle samples, e.g., microliter-sized samples. The systems and methods may characterize particles in the samples by obtaining light scattering data from multiple angles. The data obtained in this manner may allow a greater dynamic range of particle sizing than when using a single angle. Additionally, quantitative data on how much of each size of particle in the sample may be obtained. The systems and methods may combine the absolute correlation function at each angle to give a single angle independent result, and may help measure previously hidden particle size populations (e.g., due to weak scatter) and/or generate a more complete size distribution. In some variations, the dynamic light scattering measurements may be obtained using systems including a single rotating light detector, e.g., a single rotating light fiber. The single light detector may be rotated above a sample plate holding a plurality of samples to detect scattered light at multiple angles for particle characterization.

The systems for characterizing particles may include one or more processors, a plurality of samples, and a first module configured to measure light scattered by each sample of the plurality of samples. Each sample of the plurality of samples may include one or more types of particles. The samples may include any type of particle that scatters light when illuminated. Exemplary types of particles may include without limitation, nanoparticles, DNA, RNA, viruses, proteins, polymers, small molecules, and combinations thereof.

In one variation, the first module may comprise one or more light emitters, an actuator having a rotation axis, and a single light detector configured to rotate about the rotation axis and receive light scattered by each sample at the plurality of scatter angles. The one or more light emitters may comprise a laser light source. In some variations, the one or more light emitters of the first module of the system may include two light emitters, a first light emitter and a second light emitter. The first light emitter may be disposed above a sample plate, and the second light emitter may be disposed below the sample plate. It is understood that the light emitters may be configured in various other ways.

The plurality of samples may be held on a sample plate of the system. More specifically, the plurality of samples may be held in a plurality of cuvettes on the sample plate. In some variations, each sample of the plurality of samples on the sample plate may include the same type of particle. In other variations, each sample of the plurality of samples on the sample plate may include a different type of particle. In further variations, each sample of the plurality of samples may include a mixture of particles. In yet further variations, some samples on the sample plate may include the same particle or the same mixture of particles, and other samples on the plate may include a different type of particle or a different mixture of particles.

The first module may be further configured to adjust a position of an emitting beam axis so that an intersection (beam overlap) between the emitting beam axis and a detector beam axis is restored during each rotation of the light detector and/or when the illumination direction is changed (e.g., illumination from the top of the sample plate is changed to illumination from below the sample plate and vice versa). The first module may be configured so that the position of the emitting beam axis may be automatically or manually adjusted. Additionally, the first module may be configured to include a mechanism that maintains the beam overlap at the same height in the plurality of cuvettes of the sample plate. Some variations of the system may include a second module configured to automatically adjust the position of the sample plate according to instructions from the one or more processors.

Instead of multiple light detectors, the systems described herein generally include a single light detector. The single light detector may be configured to rotate from about 1.0 degree to about 280 degrees about the rotation axis of an actuator that rotates, including all values and sub-ranges therein. The single light detector may comprise an optical fiber.

The single light detector may be configured to receive forward light scattering from a plurality of scatter angles ranging from about 25 degrees to about 45 degrees, including all values and sub-ranges therein. With respect to backward light scattering, the single light detector may be configured to receive backward light scattering from a plurality of scatter angles ranging from about 105 degrees to about 170 degrees, including all values and sub-ranges therein.

Some variations of the systems described herein may also be configured to obtain UV/Vis data from the plurality of samples. In these variations, the systems may include a third module configured to illuminate the plurality of samples with light having a wavelength ranging from about 190 nm to about 900 nm, and measure an absorbance of the plurality of samples. The particles in these samples may be those mentioned above, e.g., nanoparticles, DNA, RNA, viruses, proteins, polymers, and/or small molecules.

The volume of the samples analyzed by the systems may be quite small, ranging from about 0.5 μl to about 2.5 μl, including all values and sub-ranges therein. In one variation, the volume of the plurality of samples is about 2 μl. In another variation, the volume of the plurality of samples is about 2 μl or less.

The sample plate may be variously sized. For example, the sample plate may have a length ranging from about 11 cm to about 13 cm (including all values and sub-ranges therein), and a width ranging from about 7.0 cm to about 9.0 cm (including all values and sub-ranges therein). In one instance, the sample plate may have a length of about 12.8 cm and a width of about 8.5 cm.

The sample plate may also be configured in various ways. In some variations, the sample plate may comprise a plurality of members, where each member of the plurality of members may be configured as a strip (referred to herein as “chip” or “microfluidic chip”) having a length and a width. The length of the strip may range from about 7.0 cm to about 9.0 cm (including all values and sub-ranges therein), and the width of the strip may range from about 1.0 cm to about 3.0 cm (including all values and sub-ranges therein). For example, it may be useful for the strip to have a length of about 8.1 cm and a width of about 1.8 cm. Any suitable number of strips may be included on the sample plate, e.g., 1, 2, 3, 4, 5, 6, 7, 8, 9, or 10. In one variation, the sample plate may include six strips.

Each strip may comprise a plurality of wells configured to receive a sample. Each well of the plurality of wells may be coupled to a corresponding cuvette (from the plurality of cuvettes) by a channel, e.g., a microchannel. The cuvettes may have a path length ranging from about 0.1 mm to about 0.7 mm, including all values and sub-ranges therein. In some variations, the path length of the cuvette is about 0.1 mm. In other variations, the path length of the cuvette is about 0.7 mm.

The one or more processors of the system may be configured to determine a size of the one or more types of particles in the sample based on data from the scattered light. The size of the one or more types of particles in the sample may range from about 0.3 nm to about 3,000 nm, including all values and sub-ranges therein. For example, the size of the one or more particles may be about 0.3 nm, about 0.4 nm, about 0.5 nm, about 0.6 nm, about 0.7 nm, about 0.8 nm, about 0.9 nm, about 1.0 nm, about 1.5 nm, about 2.0 nm, about 2.5 nm, about 3.0 nm, about 3.5 nm, about 4.0 nm, about 4.5 nm, about 5.0 nm, about 5.5 nm, about 6.0 nm, about 6.5 nm, about 7.0 nm, about 7.5 nm, about 8.0 nm, about 8.5 nm, about 9.0 nm, about 9.5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 1,000 nm, about 1,500 nm, about 2,000 nm, about 2,500 nm, or about 3,000 nm. The one or more processors may be configured to receive a plurality of signals from the single light detector, where each signal of the plurality of signals may be representative of scattered light at a particular angle. Data from light scattered at multiple (e.g., different) angles may then be combined and analyzed by the one or more processors to determine a single result that may be angle independent. In some variations, the one or more processors may employ algorithms configured to determine particle size using data and/or signals relating to one or more of sample temperature, sample viscosity, hydrodynamic diameter of the particle, intensity of scattered light, ratio of the intensity of scattered light at a specific angle to incident light intensity, angle of scattered light, and rate of change of the intensity of scattered light (e.g., the fluctuation of the intensity of scattered light over time). The one or more processors may comprise a correlator configured to analyze particles size based on the data and/or intensity of the various signals described above.

Methods for characterizing particles are also described herein. Exemplary particles include without limitation, nanoparticles, DNA, RNA, viruses, proteins, polymers, and/or small molecules. In general, the methods may include illuminating a plurality of samples with light from one or more light emitters, where each sample of the plurality of samples contains one or more types of particles; rotating a light detector about a rotation axis over a plurality of scatter angles; detecting light scattered by the particles over the plurality of scatter angles; and obtaining a light scattering measurement for each scatter angle of the plurality of scatter angles. As mentioned above, data from light scattered at the plurality of scatter angles may then be combined and analyzed by the one or more processors to determine a single result that may be angle independent.

The one or more light emitters may comprise a laser light source. It is understood that suitable alternative light sources may also be employed. Some variations of the method may utilize a first light emitter and a second light emitter. In these variations, the first light emitter may be disposed above the plurality of samples, and the second light emitter may be disposed below the plurality of samples.

In some variations, the method may further include adjusting a position of an emitting beam axis so that an intersection between the emitting beam axis and a detector axis is maintained at the same height in a plurality of cuvettes contained in a sample plate. The position of the emitting beam axis may be manually adjusted or automatically adjusted according to instructions from one or more processors. Similarly, the position of the sample plate may be manually or automatically adjusted.

The automatic adjustment of the emitting beam axis may be based on instructions from the one or more processors that include one or more preliminary positioning steps. For example, the one or more preliminary positioning steps may include moving the one or more light emitters to a smallest circle on a hyperboloid. In some variations, the method may further include one or more fine positioning steps such as determining a maximal intensity of the light scattered by each sample at the plurality of scatter angles.

When the light detector is rotated to obtain scattered light at multiple angles, the rotation angle may range from about 1 degree to about 280 degrees about a rotation axis of the actuator, including all values and sub-ranges therein. Forward light scattering may be detected at a plurality of scatter angles ranging from about 25 degrees to about 45 degrees, including all values and sub-ranges therein, and backward light scattering may be detected at a plurality of scatter angles ranging from about 105 degrees to about 170 degrees, including all values and sub-ranges therein.

Additionally, the method may include obtain UV/Vis data from the plurality of samples. For example, the plurality of samples may be illuminated with light having a wavelength ranging from about 190 nm to about 900 nm and absorbance measured.

Characterization of particles may be accomplished on small sample volumes ranging from about 0.5 μl to about 2.5 μl, including all values and sub-ranges therein. In one variation, the volume of the plurality of samples is about 2 μl. In another variation, the volume of the plurality of samples is about 2 μl or less.

Determining the size of the one or more types of particles in the sample may be accomplished by one or more processors of the system configured to analyze data from the scattered light. The size of the one or more types of particles in the sample may range from about 0.3 nm to about 3,000 nm, including all values and sub-ranges therein, as described above. Once signals are obtained from scattered light detected by the single light detector at multiple scatter angles, the data from the light scattered at multiple (e.g., different) angles may then be combined and analyzed by the one or more processors to determine a single result (e.g., single solution). The single result may be angle independent. In some variations, the one or more processors may determine the size of the one or more types of particles in each sample based on a shape of an absolute correlation function of the plurality of scatter angles.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A depicts a front view of the housing of an exemplary system for measuring light scattering at multiple angles.

FIG. 1B depicts the modules within the interior of the housing shown in FIG. 1A.

FIG. 2A depicts a perspective view of an exemplary first module (dynamic light scattering module) of a system for measuring light scattering at multiple angles.

FIGS. 2B and 2C depict an exemplary actuator configured to rotate a light detector so that scattered light may be detected at a plurality of scatter angles.

FIGS. 3A and 3B depict examples of beam overlap between emitting beams and receiving beams upon rotation of the light detector. In FIG. 3A, the beam overlap is restored. In FIG. 3B, the beam overlap has not been restored.

FIG. 3C shows an exemplary first module including a stage configured to move the one or more light emitters in a horizontal plane in the X′ and/or Y′ direction so that beam overlap may be restored.

FIG. 4A depicts an exemplary first module including an actuator configured to translate the entire first module in the up and down directions so that the beam overlap may occur at the same height in a cuvette(s).

FIGS. 4B and 4C illustrate the beam overlap being at the same height in a cuvette when the cuvette is illuminated from the top of the sample plate (FIG. 4B) and from bottom of the sample plate (FIG. 4C).

FIG. 5A depicts an exemplary sample plate.

FIG. 5B shows one strip of the plurality of strips provided on the sample plate of FIG. 5A.

FIG. 5C is an enlarged view of the structure of the strip shown in FIG. 5B.

FIGS. 6A-6D depict an exemplary sample characterization cycle of the system.

FIGS. 7A-7D illustrate an exemplary algorithm for restoring beam overlap.

FIGS. 8A-8C depict exemplary 2D representations of absolute correlation functions whose shape may help determine the size of the one or more types of particles in samples.

### DETAILED DESCRIPTION

Described herein are systems and methods that obtain dynamic light scattering data from particle samples, and in some instances, also measure the UV/Vis absorption spectrum of the particle samples. The systems and methods may characterize particles in the samples by obtaining light scattering data from multiple angles using a single light detector that rotates due to rotation of an actuator to which it is coupled to. The data obtained in this manner may allow a greater dynamic range of particle sizing than when using a single angle. The systems and methods may combine the absolute correlation function at each angle to give a single angle independent result. Furthermore, the systems and methods may be designed for manual, automated, or both types of workflows (e.g., switching between manual and automated, and vice versa).

### Systems

The systems described herein may include various modules that may individually or collectively help characterize particles in one or more samples. In general, the systems may be sized and/or shaped to be portable and/or capable of fitting on a lab bench, table, shelf, etc. In some variations, the systems may include at least a first module, a second module, and a third module contained within a housing, and which may be configured to characterize particle samples and/or position the samples for characterization.

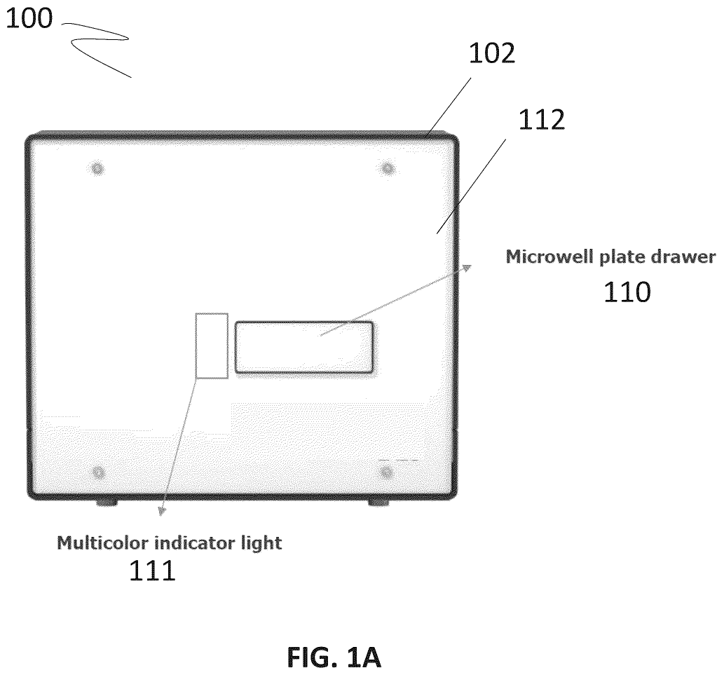

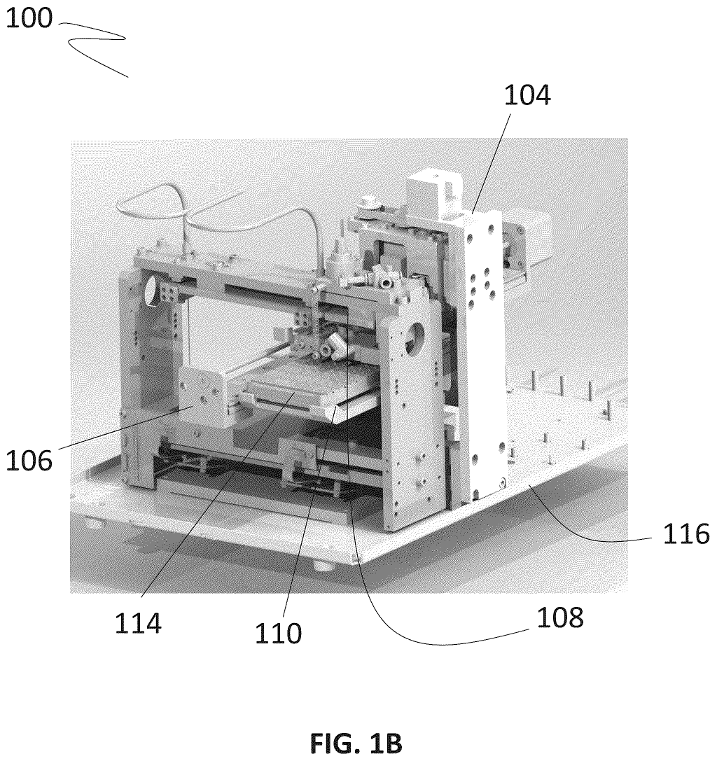

For example, as shown in FIGS. 1A and 1B, the system (100) may include a housing (102) within which a first module (104), a second module (106), and a third module (108) may reside on a baseplate (116). A plate drawer, e.g., microplate drawer (110) of the second module (106) may be configured to open and extend through a front wall (112) of the housing (102) to an open position so that a sample plate (114) may be inserted into the drawer (110), and retract back into the housing (102) to a closed position in order to place the sample plate (114) within the housing (102). Once disposed within the housing (102), the plurality of samples in the sample plate (114) may be analyzed by one or more of modules of the system (100). A multi-indicator light (111) may further be provided on the front wall (112) of the housing (102) to indicate the status (e.g., various states) of the system. For example, a flashing white light may indicate that the system is booting up; a full white light may indicate that the system has booted up correctly and is ready to use; a flashing blue light may indicate that the microplate drawer is moving in/out or is open, a plate is still inside the system, and/or the system is still measuring; a full red light may indicate that the system is in an error state; a flashing red light may indicate that the microplate drawer is obstructed; and a flashing yellow light may indicate a self-test mode after startup.

One module of the system may be coupled to one or more different modules of the system via a mechanical connection (e.g., by a cable), or a wireless connection. Components of the system, e.g., housing, modules, sample plates, may be made from any suitable material, e.g., any suitable polymeric material, metal material, or glass material, or any suitable combination of materials.

### First Module (Dynamic Light Scattering Module)

As previously described, the systems for characterizing particles may include one or more processors, a plurality of samples, and a first module configured to measure light scattered by each sample of the plurality of samples. The one or more processors may be coupled to the first module (and/or other modules, e.g., second or third modules) by a wired or wireless connection. Each sample of the plurality of samples may include one or more types of particles. The samples may include any type of particle that scatters light when illuminated. Exemplary types of particles may include without limitation, nanoparticles, DNA, RNA, viruses, proteins, polymers, small molecules, and combinations thereof.

The first module may include one or more light emitters, a single light detector, and an actuator having a rotation axis. The one or more light emitters may include a source of laser light. The laser light source may be any laser source or configuration capable of providing monochromatic and/or polarized light. In some variations, the laser source may have a power of about 40 mW and may produce wavelengths of about 660 nm. When a plurality of light emitters are employed, they may include the same or different laser sources. The laser source(s) may be contained within the housing of the system.

The single light detector may comprise an optical fiber and be coupled to the actuator. Coupling between the light detector and actuator may be accomplished using a clamp, a threaded or keyed connection, or other types of connections. In some variations, the single light detector may be coupled to the actuator by a clamp such that rotation of the actuator in turn rotates the light detector about the rotation axis of the actuator. Rotation of the single light detector about the rotation axis may allow the light detector to receive light scattered by each sample at a plurality of scatter angles. The single light detector may be rotated above a sample plate holding a plurality of samples to detect scattered light at multiple scatter angles.

In some variations, the single light detector may rotate from about 1.0 degree to about 280 degrees about the rotation axis, including all values and sub-ranges therein. Put another way, the angle sweep of the single light detector may range from about 1.0 degree to about 280 degrees, including all values and sub-ranges therein. For example, the single light detector may rotate about the rotation axis about 1.0 degree, 5.0 degrees, 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, about 120 degrees, about 125 degrees, about 130 degrees, about 135 degrees, about 140 degrees, about 145 degrees, about 150 degrees, about 155 degrees, about 160 degrees, about 165 degrees, about 170 degrees, about 175 degrees, about 180 degrees, about 185 degrees, about 190 degrees, about 195 degrees, about 200 degrees, about 205 degrees, about 210 degrees, about 215 degrees, about 220 degrees, about 225 degrees, about 250 degrees, about 255 degrees, about 260 degrees, about 265 degrees, about 270 degrees, about 275 degrees, or about 280 degrees. In some variations, the single light detector may rotate 280 degrees about the rotation axis, or greater than 280 degrees about the rotation axis. In other variations, rotation of the actuator between about 30 degrees and about 180 degrees also rotates the single light detector by a corresponding number of degrees.

The scattered light received by the single light detector may include forward scattered light and/or backward scattered light from the plurality of scatter angles. When forward light scattering is received, the plurality of scatter angles may range from about 25 degrees to about 45 degrees, including all values and sub-ranges therein. For example, a forward light scattering angle of the plurality of scatter angles may be about 25 degrees, about 26 degrees, about 27 degrees, about 28 degrees, about 29 degrees, about 30 degrees, about 31 degrees, about 32 degrees, about 33 degrees, about 34 degrees, about 35 degrees, about 36 degrees, about 37 degrees, about 38 degrees, about 39 degrees, about 40 degrees, about 41 degrees, about 42 degrees, about 43 degrees, about 44 degrees, or about 45 degrees.

When backward light scattering is received, the plurality of scatter angles may range from about 105 degrees to about 170 degrees, including all values and sub-ranges therein. For example, a backward light scattering angle of the plurality of scatter angles may be about 105 degrees, about 106 degrees, about 107 degrees, about 108 degrees, about 109 degrees, about 110 degrees, about 111 degrees, about 112 degrees, about 113 degrees, about 114 degrees, about 115 degrees, about 116 degrees, about 117 degrees, about 118 degrees, about 119 degrees, about 120 degrees, about 121 degrees, about 122 degrees, about 123 degrees, about 124 degrees, about 125 degrees, about 126 degrees, about 127 degrees, about 128 degrees, about 129 degrees, about 130 degrees, about 131 degrees, 132 degrees, 133 degrees, about 134 degrees, about 135 degrees, about 136 degrees, about 137 degrees, about 138 degrees, about 139 degrees, about 140 degrees, about 141 degrees, about 142 degrees, about 143 degrees, about 144 degrees, about 145 degrees, about 146 degrees, about 147 degrees, about 148 degrees, about 149 degrees, about 150 degrees, about 151 degrees, about 152 degrees, about 153 degrees, about 154 degrees, about 155 degrees, about 156 degrees, about 157 degrees, about 158 degrees, about 159 degrees, about 160 degrees, about 161 degrees, about 162 degrees, about 163 degrees, about 164 degrees, about 165 degrees, about 166 degrees, about 167 degrees, about 168 degrees, about 169 degrees, or about 170 degrees.

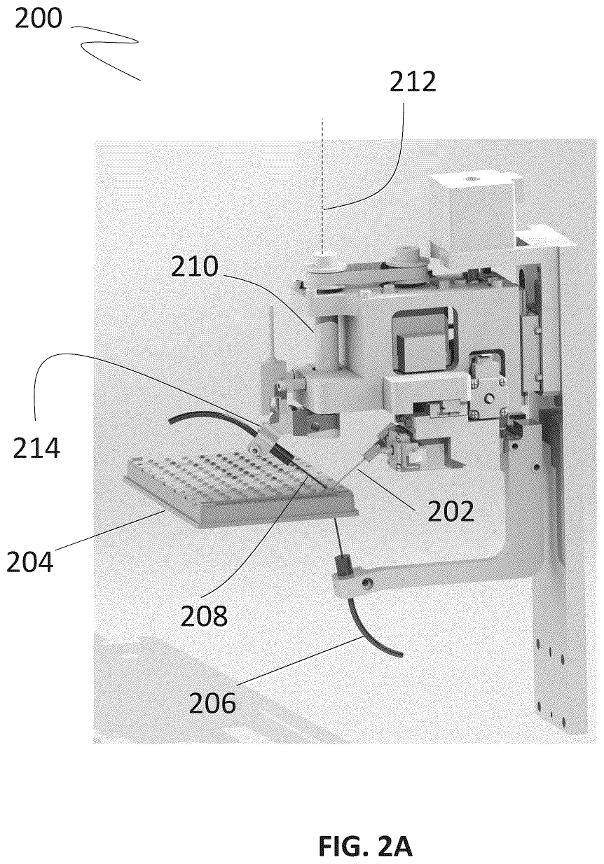

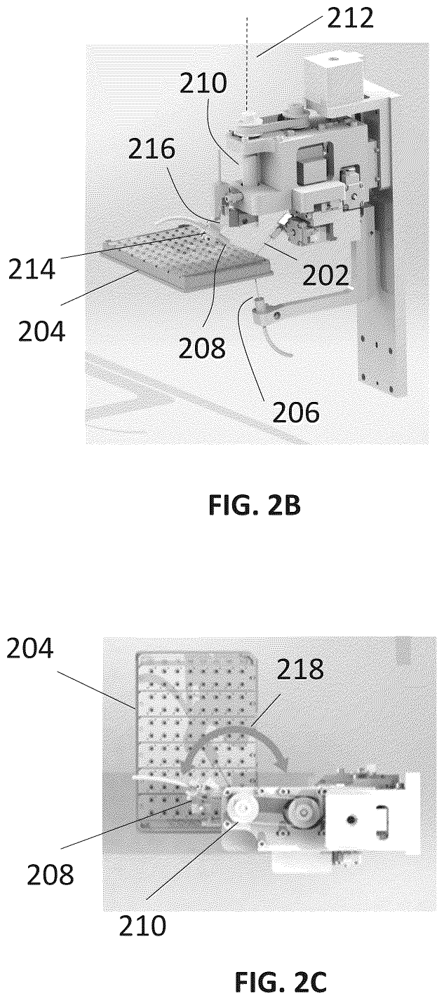

The light emitter may be an optical fiber and may include a source of laser light (e.g., a monochromatic light source), as described above. The system may include one or more light emitters. When a plurality of light emitters are employed, they may be connected to the same or different laser sources. In some variations, the one or more light emitters may include two light emitters, a first light emitter and a second light emitter. The first and second light emitters may be configured in the system such that first light emitter is disposed above a sample plate, and the second light emitter is disposed below the sample plate. For example, as shown in FIG. 2A, the first module (200) (configured to at least emit light and detect scattered light) may include a first light emitter (202) positioned above a sample plate (204) and a second light emitter (206) positioned below the sample plate (204). Illumination by the first and second light emitters may be sequential (i.e., not simultaneous). The first light emitter (202), which illuminates samples in the sample plate (204) from the top, may result in backward light scattering. The second light emitter (206), which illuminates samples in the sample plate (204) from the bottom, may result in forward light scattering.

The system may include a single light detector configured to receive scattered light at a plurality of scatter angles, as previously stated. The single light detector may be connected to a photon counter and have a detector beam axis that is parallel to longitudinal axis of the light detector. In some variations, the single light detector may be an optical fiber coupled to a rotational actuator in a manner that rotates the optical fiber when the actuator is rotated about its rotation axis (e.g., its longitudinal axis). For example, referring to FIGS. 2A and 2B, the single light detector (208), which is positioned above sample plate (204), may be coupled to an actuator (210) that may be configured to rotate about a rotation axis (212). More specifically, the single light detector (208) may be coupled to the actuator (210) via a clamp (214) on a swing arm (216) of the actuator (210). As shown in FIG. 2C, the actuator (210) may rotate the light detector (208) in the direction of arrows (218). Rotation may be between about 1.0 degree and about 280 degrees about the rotation axis (212), including all values and sub-ranges therein. In some variations, the angle of the swing arm (216) may be moved in increments of about 1.8 degrees. This extensive angle sweep may allow a larger amount of scattered light to be detected and analyzed, and thus result in more accurately size particles within the samples. In one variation, rotating the light detector and selecting illumination by either the first (e.g., above sample plate) and/or second (e.g., below sample plate) light emitter may be included in the procedure for setting up the scatter angles for which light scattering is to be detected for a sample. The illumination from the light emitters may have an emitting beam axis which is parallel to longitudinal axis of the light emitter from which it originates.

As further described below, the samples plates may include a plurality of cuvettes that contain small volumes of the sample for characterization/analysis. The first module may be configured to adjust a position of the emitting beam axis so that an intersection (beam overlap) between the emitting beam axis and a detector beam axis is maintained. The adjustment may be accomplished using one or more actuators, e.g., stepper motors. The actuators may be manually adjusted or adjusted automatically based on instructions from one or more system processors. Given that any deformation in the sample plate (e.g., sample plate surface) may deform the optical paths of the emitting beam and/or receiving beam (that includes light scattered at a particular scatter angle), each time the light detector is moved (e.g., rotated) and/or the illumination direction changes (e.g., from above to below the sample plate and vice versa), it may be useful to restore the intersection of the emitting and receiving beams so that the beam overlap occurs at the same position (which may help improve accuracy of the obtained data).

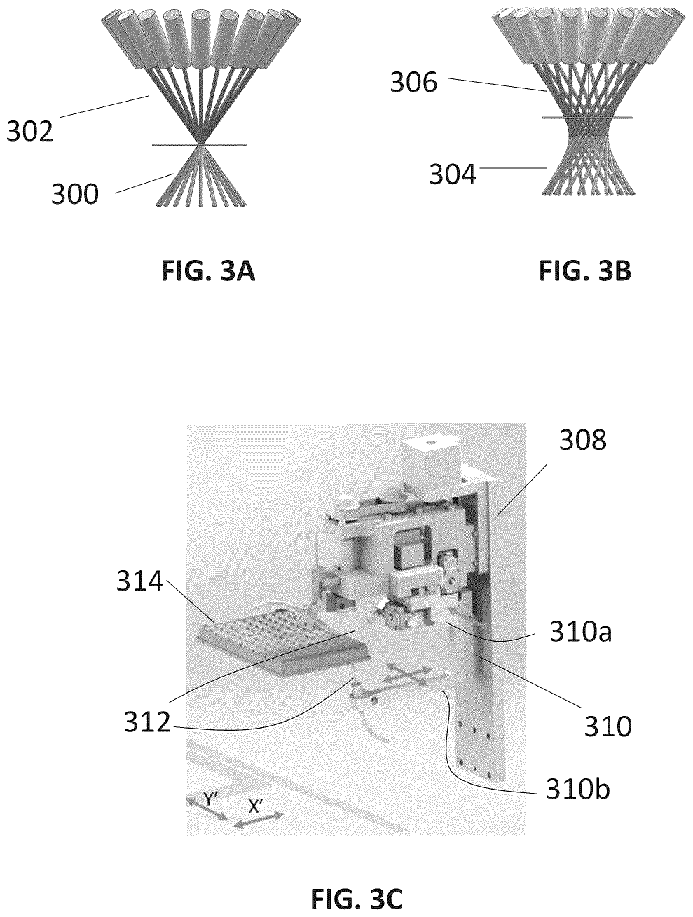

For example, referring to FIG. 3A, it may be useful to restore the beam overlap of the emitting beams (300) and receiving beams (302) as the light detector is rotated so that the overlap forms a cone shape. Without restoring the beam overlap, the emitting beams (304) and receiving beams (306) may form a hyperboloid, as shown in FIG. 3B. Imperfections in the swing arm and light detector facet may also contribute to deformations in optical paths of the emitting and receiving beams. The first module may include a stage configured to move the one or more light emitters in a horizontal plane in the X′ and/or Y′ direction so that the beam overlap may be restored. For example, referring to FIG. 3C, the first module (308) may include stage (310) including a first stage actuator (310a) configured to translate the light emitters (312) (one emitter positioned above the sample plate (314) and one emitter positioned below the sample plate (314)) in the Y′ direction, and a second stage actuator (310b) configured to translate the light emitters (312) in the X′ direction.

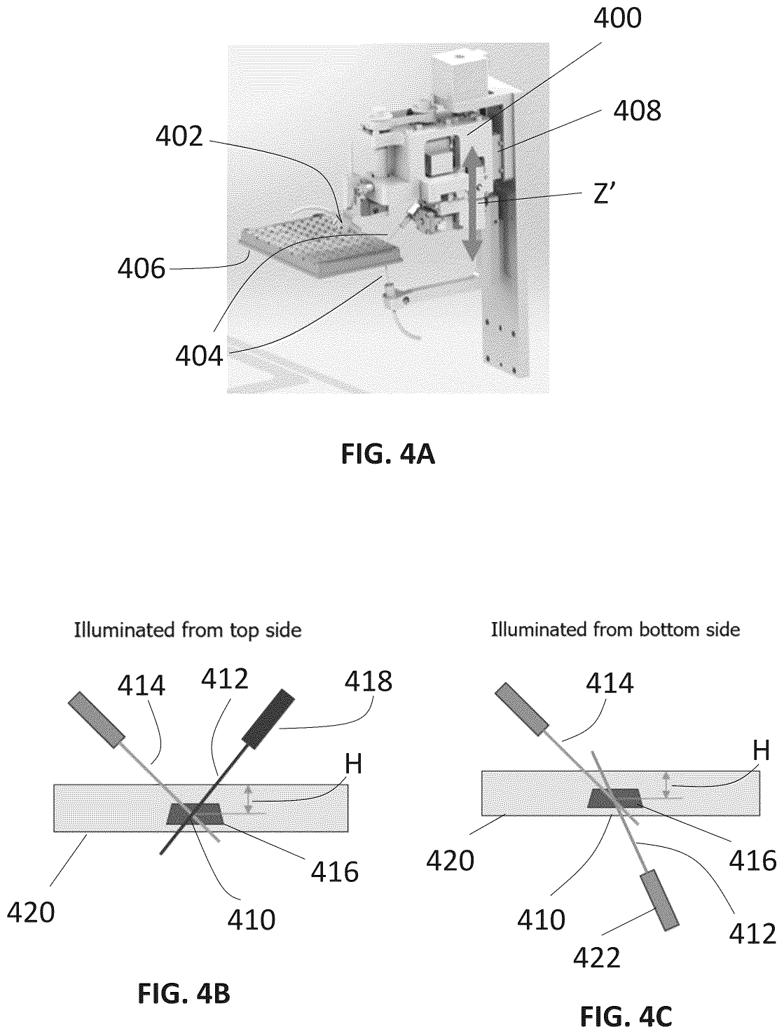

The first module may further include a third stage actuator (e.g., a stepper motor) configured to translate the light detector and/or light emitters in a vertical plane in the Z′ direction so that the intersection of the emitting and receiving beams (beam overlap) occurs at the same height in the plurality of cuvettes. For example, referring to FIG. 4A, the first module (400) may include a third stage actuator (408) configured to translate the first module (400) and associated single light detector (402) and/or light emitters (404) (one emitter positioned above the sample plate (406) and one emitter positioned below the sample plate (406)) in the up and down direction, e.g., the Z′ direction. As further detailed in FIGS. 4B and 4C, the beam overlap (410) of the emitting beam (412) and receiving beam (414) is maintained at the same height (H) in the cuvette (416). FIG. 4B shows the beam overlap (410) when illumination is from a light emitter (418) above the sample plate (420), and FIG. 4C shows the beam overlap (410) when illumination is from a light emitter (422) below the sample plate (420). In one variation, when the cuvette is 0.7 mm in height, it may be useful to maintain the intersection at a height of 0.35 mm in each cuvette of the plurality of cuvettes.

### Second Module (Sample Plate Positioning Module)

Some variations of the systems described herein may include a second module configured to move the sample plate to a position in which it is desired to obtain a light scattering and/or UV/Vis measurement. For example, referring to FIG. 1B, the second module (106) may include a microplate drawer (110) configured receive a sample plate (114) therein and adjust the position of the sample plate (114) within the housing (102) in order to obtain light scattering and/or absorbance data. The second module may be configured for manual or automatic translation. One or more second module actuators (e.g., motors) may be used to effect sample plate positioning. For example, the one or more second module actuators may be used to move the sample plate such that each cuvette is appropriately positioned for obtaining measurements by the single light detector and/or for moving the plate so that each cuvette of the sample plate may be analyzed sequentially. When the position adjustment is automatic, the second module may be configured to receive instructions from one or more processors of the system based on information input by a user, or based on data/information, e.g., from system calibration, type(s) of particles being sampled, size of the cuvettes, etc. The single light detector may be rotated above a sample plate holding a plurality of samples to detect scattered light at multiple scatter angles.

The sample plates positioned within the second module may be disposable and configured in various ways, but in general may be structured to hold one or more samples. When the plates contain a plurality of samples, they may hold between 2 to 96 samples. For example, the plates may hold 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, or 96 samples. In some variations, the sample plates may be designed for automated, high-throughput use (e.g., by employing a stackable design and including a bar code for tracking). The sample plates may also be configured for the manual pipetting of samples or configured to be compatible with liquid handling robots that input samples into wells of the plate.

The sample plates may have a length ranging from about 11 cm to about 13 cm, including all values and sub-ranges therein. For example, the length of the sample plates may be about 11 cm, about 11.5 cm, about 12 cm, about 12.5 cm, or about 13 cm. The width of the sample plates may range from about 7.0 cm to about 9.0 cm, including all values and sub-ranges therein. For example, the sample plate width may be about 7.0 cm, about 7.5 cm, about 8.0 cm, about 8.5 cm, or about 9.0 cm. In one variation, the sample plate may have a length of about 12.8 cm and a width of about 8.5 cm. With respect to materials, the sample plates may be made from polymers (e.g., thermoplastic polymers), plastics, metals, glass, or combinations thereof. In one variation, the sample plate may be made from acrylonitrile butadiene styrene (ABS).

In some variations, the sample plate may include a plurality of cuvettes within which the samples are contained to obtain light scattering and/or absorbance data. The plurality of cuvettes may be disposed on a member configured as a strip (also referred to herein as a “chip” or “microfluidic chip”). The sample plate may include one strip or a plurality of strips. For example, the sample plate may include 1, 2, 3, 4, 5, 6, 7, 8, 9, or 10 strips. In some variations, it may be beneficial for the sample plate to include six strips. The one or more strips may be pre-mounted on a substrate of the plate.

The strip may have a length and a width. The length of the strip may range from about 7.0 cm to about 9.0 cm, including all values and sub-ranges therein. For example, the strip may have a length of about 7.0 cm, about 7.5 cm, about 8.0 cm, about 8.5 cm, or about 9.0 cm. The width of the strip may range from about 1.0 cm to about 3.0 cm, including all values and sub-ranges therein. For example, the width of the strip may be about 1.0 cm, about 1.5 cm, about 2.0 cm, about 2.5 cm, or about 3.0 cm. In one variation, it may be useful for the strip to have a length of about 8.1 cm and a width of about 1.8 cm. The strips may be made from any suitable material, including without limitation, polymers (e.g., thermoplastic polymers), plastics, glass, and combinations thereof. In one variation, the strip may be made from a cyclic olefin copolymer (COC). In another variation, the strip may be made from glass. In a further variation, the strip may be formed from a material that makes it transparent.

A plurality of wells (e.g., input wells) configured to receive a sample may also be included on the strip. The strip may include any number of wells. For example, the strip may include 1, 2, 3, 4, 5, 6, 7, 8, 9, 10, 11, 12, 13, 14, 15, or 16 wells. The wells may have a conical shape to fit the tip of a pipette, but other shapes may be used. The samples input into the plurality of wells may be the same or different. Sample volumes may be very small, ranging from about 0.1 μl to about 2.5 μl, including all values and sub-ranges therein. For example, the sample volume may be about 0.1 μl, about 0.2 μl, about 0.3 μl, about 0.4 μl, about 0.5 μl, about 0.6 μl, about 0.7 μl, about 0.8 μl, about 0.9 μl, about 1.0 μl, about 1.1 μl, about 1.2 μl, about 1.3 μl, about 1.4 μl, about 1.5 μl, about 1.6 μl, about 1.7 μl, about 1.8 μl, about 1.9 μl, about 2.0 μl, about 2.1 μl, about 2.2 μl, about 2.3 μl, about 2.4 μl, or about 2.5 μl. In one variation, the volume of the at least one sample may be about 2.0 μl. In another variation, the volume of the at least one sample may be about 2.0 μl or less. The samples may include one or more types of particles. As previously described herein, the one or more types of particles may be without limitation, nanoparticles, DNA, RNA, viruses, proteins, polymers, and/or small molecules. The size of the one or more types of particles in the sample may range from about 0.3 nm to about 3,000 nm, including all values and sub-ranges therein. For example, the size of the one or more particles may be about 0.3 nm, about 0.4 nm, about 0.5 nm, about 0.6 nm, about 0.7 nm, about 0.8 nm, about 0.9 nm, about 1.0 nm, about 1.5 nm, about 2.0 nm, about 2.5 nm, about 3.0 nm, about 3.5 nm, about 4.0 nm, about 4.5 nm, about 5.0 nm, about 5.5 nm, about 6.0 nm, about 6.5 nm, about 7.0 nm, about 7.5 nm, about 8.0 nm, about 8.5 nm, about 9.0 nm, about 9.5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 1,000 nm, about 1,500 nm, about 2,000 nm, about 2,500 nm, or about 3,000 nm.

The strips may be configured such that the sample placed in a well flows to one or more cuvettes for analysis via at least one channel, e.g., at least one microchannel. The cuvettes may have a path length ranging from about 0.1 mm to about 0.7 mm, including all values and sub-ranges therein. For example, the path length may be about 0.1 mm, about 0.2 mm, about 0.3 mm, about 0.4 mm, about 0.5 mm, about 0.6 mm, or about 0.7 mm. In some variations, the path length of the cuvette is about 0.1 mm. In other variations, the path length of the cuvette is about 0.7 mm.

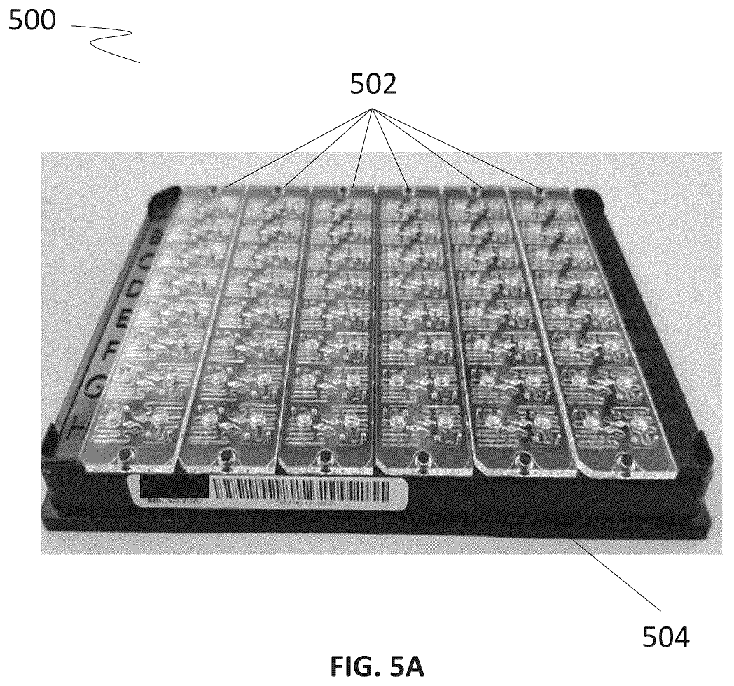

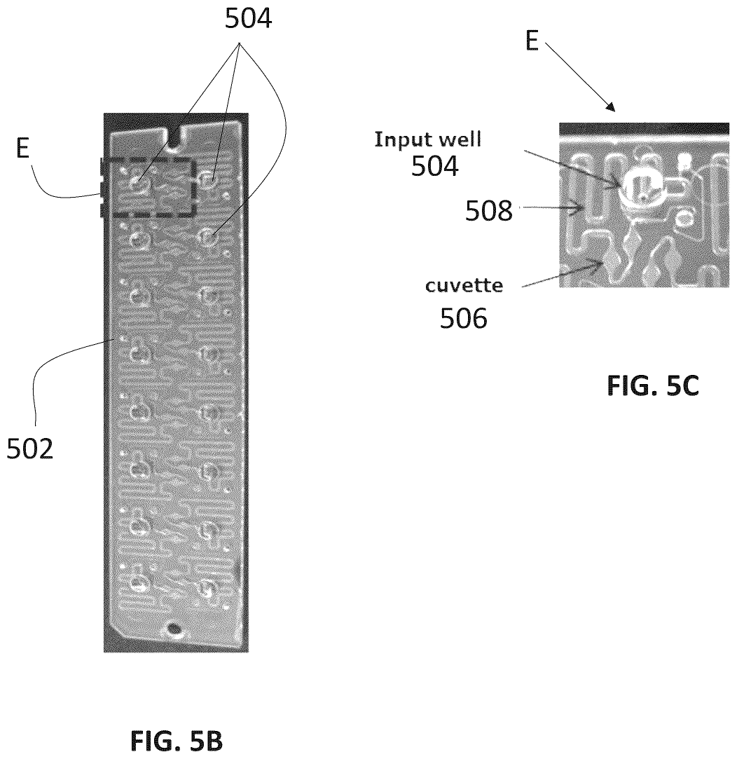

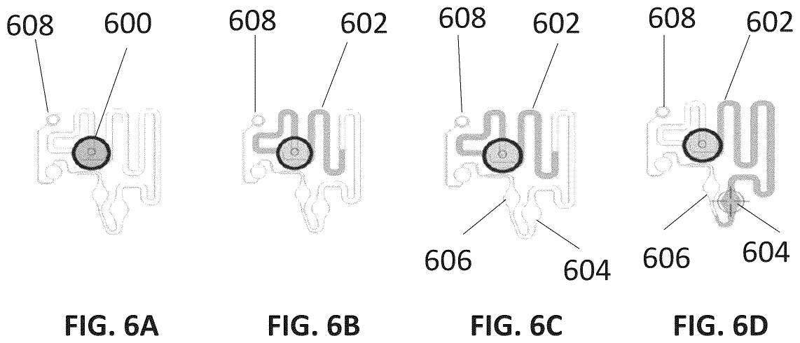

In some variations, the sample plate may be configured as shown in FIG. 5A. Referring to FIG. 5A, sample plate (500) may include a plurality of strips, e.g., six strips (502), on a substrate (504). A top view of one of the six strips (502) is separately provided in FIG. 5B showing the configuration of a plurality of wells (504) disposed on the strip (502). An enlarged view of the boxed area (E) is provided in FIG. 5C. In FIG. 5C, one well (504) of the plurality of wells is illustrated as being fluidly connected to at least one cuvette (506) via a channel (508). Although the cuvette (506) is shown as being shaped like a rounded diamond, other shapes may be employed. For example, the cuvettes may be shaped as circles, ovals, triangles, squares, or rectangles. Referring to FIGS. 6A-6D, after placement into a well (600) (FIG. 6A), the sample (yellow) may be drawn by capillary forces into channel (602) (FIG. 6B) to avoid evaporation. Next, the empty cuvettes (604, 606) are read (FIG. 6C). A small vacuum pressure (e.g., about 20 mm Hg) from one or more pumps of the system may then be applied to vent holes (608) to move the sample into cuvette (604) and/or cuvette (606), and light scattering measurements taken (FIG. 6D). The pump may be contained within the housing of the system, or may be located external to the system housing.

### Third Module (Spectrometer Module)

In some variations, the systems described herein may include a third module configured to perform UV/Vis spectroscopy. For example, referring to FIGS. 1A and 1B, a third module (108) may be situated adjacent to a second module (106) and a first module (104) within the housing (102). Thus, in these variations, the systems may measure both light scattering at multiple angles and absorbance of the samples as a function of wavelengths ranging from, for example, 230 nm to 750 nm. From the measured UV/Vis absorption spectrum, the quantity and quality of the particles may be calculated. Dynamic light scattering measurements obtained at a plurality of angles using the single rotating light detector of the first module may be used for particle sizing as described herein and/or aggregation detection.

In use, an absorbance measurement may be obtained from the samples after movement into one or more cuvettes. Thus, referring back to FIGS. 6A-6D, once the sample is moved into cuvette (604) and/or cuvette (606), an absorbance measurement may be obtained using the spectrometer of the third module. The absorbance measurement may be obtained before or after the light scattering measurement (described above) is obtained. In some instances, the system may simultaneously measure UV/Vis absorption through the cuvettes during the pressure-driven transport of the sample from the channel to the cuvette. This may allow the system to monitor the filling behavior of the cuvettes in addition to analyzing spectral absorbance of the sample.

The systems may include any number or combination of modules, but will typically comprise a first, second, and third module, as described herein. For example, the systems may include the first module to measure light scattering for obtaining particle size(s) and/or particle size distribution, the second module so that the sample plate and cuvettes may be appropriately positioned when taking measurements, calibrating, and/or obtaining other data, and the third module to measure absorbance of the sample(s). The first, second, and third modules may be contained within a housing of the system, as shown in FIGS. 1A and 1B. Other system components, such as vacuum pumps, laser source(s), and processors/processing units, may also be included within the housing. However, in some variations, one or more processors/processing units may be located external to the housing (e.g., in a computer) and communicatively coupled to the system modules, e.g., via a wired or wireless connection. As previously mentioned, data from light scattered at multiple (e.g., different) angles may be combined and analyzed by the one or more processors to determine a single result that may be angle independent. In some variations, the one or more processors may employ algorithms configured to determine particle size using data and/or signals relating to one or more of sample temperature, sample viscosity, hydrodynamic diameter of the particle, intensity of scattered light, ratio of the intensity of scattered light at a specific angle to incident light intensity, angle of scattered light, and rate of change of the intensity of scattered light (e.g., the fluctuation of the intensity of scattered light over time). In some variations, the one or more processors may comprise a correlator configured to analyze particles size based on the data and/or intensity of the various signals described herein.

Additionally, the system may include a display configured to show/present various types of information/data to the user, e.g., system status, alerts, sample plate information, sample and/or particle information, light scattering measurements, particle sizes, particle size distribution, absorbance measurements, other data relating to any of the foregoing, graphical representations of the measurements/data, etc. The display may be disposed on a portion of the housing, or comprise a monitor coupled to the system. The display may also include or function as a user interface by which the user may be able to control one or more modules and/or components of the system. The user interface in this instance may comprise a touch screen. In other variations, the user interface may include buttons, a keyboard, or a keypad that a user may press to interact and control various components of the system.

The one or more processors may be configured to control the operation of the system modules, other system components, and interaction thereof. Thus, the one or more processors may be configured to execute instructions for performing one or more of sizing and quantification of particles or other substances within samples. For example, the one or more processors of the system may be configured to determine a size of the one or more types of particles in the sample based on data from the scattered light. As previously mentioned, the size of the one or more types of particles in the sample may range from about 0.3 nm to about 3,000 nm, including all values and sub-ranges therein. The one or more processors may be configured to receive a plurality of signals from the single light detector, where each signal of the plurality of signals may be representative of scattered light at a particular angle. Data from light scattered at multiple (e.g., different) angles may then be combined and analyzed by the one or more processors to determine a single result that may be angle independent, as further described below.

### Methods

Methods for characterizing particles are also described herein. Exemplary particles include without limitation, nanoparticles, DNA, RNA, viruses, proteins, polymers, and/or small molecules. In general, the methods may include illuminating a plurality of samples with light from one or more light emitters, where each sample of the plurality of samples contains one or more types of particles; rotating a light detector about a rotation axis over a plurality of scatter angles; detecting light scattered by the particles over the plurality of scatter angles; and obtaining a light scattering measurement for each scatter angle of the plurality of scatter angles. Rotation of the light detector may occur above the plurality of samples (i.e., above the sample plate). As mentioned above, data from light scattered at the plurality of scatter angles may then be combined and analyzed by one or more processors to determine a single result that may be angle independent.

The one or more light emitters may comprise a laser light source. It is understood that suitable alternative light sources may also be employed. Some variations of the method may utilize a first light emitter and a second light emitter. In these variations, the first light emitter may be disposed above the plurality of samples, and the second light emitter may be disposed below the plurality of samples. When two light emitters are employed, e.g., a first light emitter above the sample plate and a second light emitter below the sample plate, illumination by each light emitter is typically sequential. Put another way, the first light emitter may illuminate each sample of the plurality of samples followed by illumination by the second light emitter, or vice versa.

Rotation may be accomplished using an actuator that rotates the light detector when the actuator is rotated about its rotation axis (e.g., its longitudinal axis). When the light detector is rotated to obtain scattered light at multiple angles, the rotation angle may range from about 1 degree to about 280 degrees about a rotation axis of the actuator, including all values and sub-ranges therein. For example, the single light detector may rotate about the rotation axis about 1.0 degree, 5.0 degrees, 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, about 120 degrees, about 125 degrees, about 130 degrees, about 135 degrees, about 140 degrees, about 145 degrees, about 150 degrees, about 155 degrees, about 160 degrees, about 165 degrees, about 170 degrees, about 175 degrees, about 180 degrees, about 185 degrees, about 190 degrees, about 195 degrees, about 200 degrees, about 205 degrees, about 210 degrees, about 215 degrees, about 220 degrees, about 225 degrees, about 250 degrees, about 255 degrees, about 260 degrees, about 265 degrees, about 270 degrees, about 275 degrees, or about 280 degrees. In some variations, the single light detector may rotate 280 degrees about the rotation axis, or greater than 280 degrees about the rotation axis. In other variations, rotation of the actuator between about 30 degrees and about 180 degrees may also rotate the single light detector by a corresponding number of degrees. This extensive angle sweep may allow a larger amount of scattered light to be detected and analyzed, and thus result in more accurately size particles within the samples.

Both forward and back scattered light may be detected by the single rotating light detector. Forward light scattering may be detected at a plurality of scatter angles ranging from about 25 degrees to about 45 degrees, including all values and sub-ranges therein. For example, a forward light scattering angle of the plurality of scatter angles may be about 25 degrees, about 26 degrees, about 27 degrees, about 28 degrees, about 29 degrees, about 30 degrees, about 31 degrees, about 32 degrees, about 33 degrees, about 34 degrees, about 35 degrees, about 36 degrees, about 37 degrees, about 38 degrees, about 39 degrees, about 40 degrees, about 41 degrees, about 42 degrees, about 43 degrees, about 44 degrees, or about 45 degrees.

Backward light scattering may be detected at a plurality of scatter angles ranging from about 105 degrees to about 170 degrees, including all values and sub-ranges therein. For example, the backward light scattering angle of the plurality of scatter angles may be about 105 degrees, about 106 degrees, about 107 degrees, about 108 degrees, about 109 degrees, about 110 degrees, about 111 degrees, about 112 degrees, about 113 degrees, about 114 degrees, about 115 degrees, about 116 degrees, about 117 degrees, about 118 degrees, about 119 degrees, about 120 degrees, about 121 degrees, about 122 degrees, about 123 degrees, about 124 degrees, about 125 degrees, about 126 degrees, about 127 degrees, about 128 degrees, about 129 degrees, about 130 degrees, about 131 degrees, 132 degrees, 133 degrees, about 134 degrees, about 135 degrees, about 136 degrees, about 137 degrees, about 138 degrees, about 139 degrees, about 140 degrees, about 141 degrees, about 142 degrees, about 143 degrees, about 144 degrees, about 145 degrees, about 146 degrees, about 147 degrees, about 148 degrees, about 149 degrees, about 150 degrees, about 151 degrees, about 152 degrees, about 153 degrees, about 154 degrees, about 155 degrees, about 156 degrees, about 157 degrees, about 158 degrees, about 159 degrees, about 160 degrees, about 161 degrees, about 162 degrees, about 163 degrees, about 164 degrees, about 165 degrees, about 166 degrees, about 167 degrees, about 168 degrees, about 169 degrees, or about 170 degrees.

In some variations, the method may further include adjusting a position of an emitting beam axis so that an intersection (beam overlap) between the emitting beam axis and a detector axis in each cuvette is restored when light scattering is measured at the plurality of scatter angles and/or when the illumination direction is changed (e.g., from the top to bottom of the plate and vice versa). Put another way, light scattering measured at a first scatter angle has a first beam overlap and light scattering measured at a second scatter angle has a second beam overlap that may be restored so that it is the same or substantially the same as the first beam overlap, as illustrated in FIG. 3A. Light scattering measured at subsequent scatter angles (e.g., third, fourth, fifth, sixth, seventh, eighth scatter angles) may also be restored so that the beam overlaps are the same or substantially the same so that the beam overlaps forms a cone rather than a hyperboloid shape, as shown by the comparison between FIG. 3A (cone) and FIG. 3B (hyperboloid). The position of the emitting beam axis may be manually adjusted, or automatically adjusted according to instructions from one or more processors. Restoration of the beam overlap may be needed to account for such factors as imperfections in the swing arm coupled to the rotating actuator or light detector facet and/or deformations of the strip surface that may deform the optical path of the emitting beam and receiving beam that includes the scattered light.

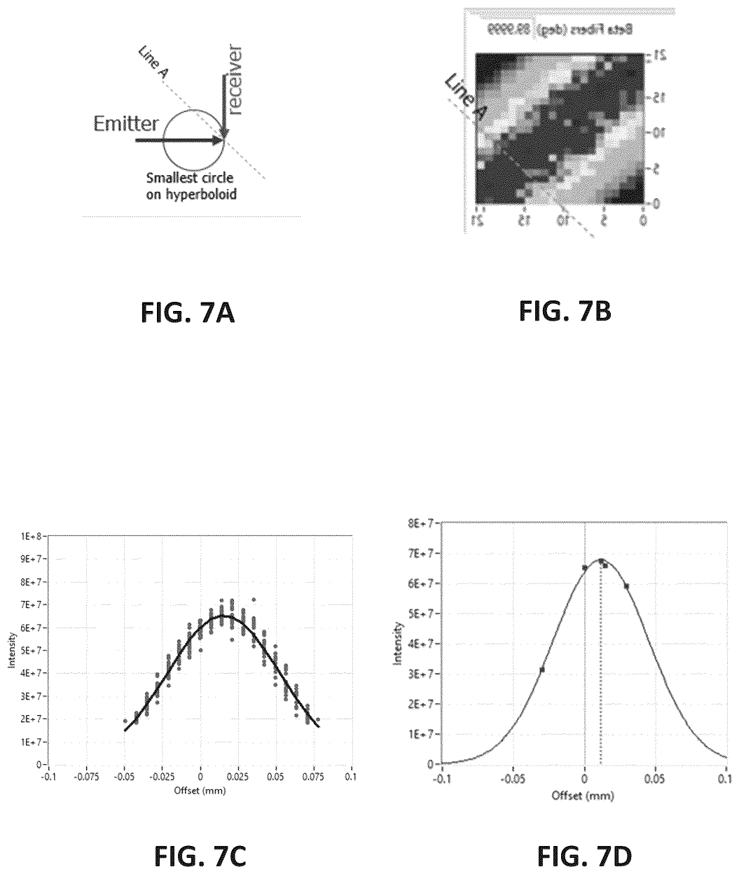

The adjustment (e.g., automatic adjustment) of the emitting beam axis to restore the beam overlap may be based on an algorithm (e.g., processing/method steps) run by the one or more processors that includes identifying a maximum intensity measurement. The algorithm may include one or more preliminary positioning steps. For example, and as illustrated in FIGS. 7A-7D, the one or more preliminary positioning steps may include moving the one or more light emitters to a theoretical position, e.g., the smallest circle, on a hyperboloid during calibration of the system (FIG. 7A). Next, the algorithm may include one or more fine positioning steps. In some variations, fine positioning may include the step of moving a light emitter (2D sweep) and creating a 2D plot of the intensity to find the desired overlap (e.g., the maximum intensity), as shown in FIG. 7B. Referring to FIGS. 7A and 7B, the intensity may be constant when moving along Line A, which is a bisector between the light emitter and the light detector. Additionally or alternatively, fine positioning may further include the step of scanning the intensity along Line A to find the maximum intensity. For example, FIG. 7C illustrates the measured intensity along Line A. Given that the intensity along Line A is known to be Gaussian, it is sufficient to measure a limited number of points (e.g., four, five, six, seven points). For each point (indicated as five black dots), as shown in FIG. 7D, the point may be fit and/or position refined on the Gaussian curve, the maximum of the curve identified, and the intensity at the maximum measured.

The methods may also include maintaining the beam overlap at the same height in each cuvette while the light scattering measurements are obtained from the plurality of cuvettes. In some variations, the same height may be maintained using an actuator, e.g., a third stage actuator as described above that may be configured to translate the light detector and/or light emitters in a vertical plane in the Z′ direction so that the intersection (beam overlap) of the emitting and receiving beams occurs at the same height in the plurality of cuvettes. The steps involved in maintaining the beam overlap may be as illustrated in FIGS. 4A-4C. Referring to FIG. 4A, the first module (400) may include a third stage actuator (408) configured to translate the first module (400) and associated single light detector (402) and/or light emitters (404) (one emitter positioned above the sample plate (406) and one emitter positioned below the sample plate (406)) in the up and down direction, e.g., the Z′ direction. As further detailed in FIGS. 4B and 4C, the beam overlap (410) of the emitting beam (412) and receiving beam (414) is maintained at the same height (H) in the cuvette (416). FIG. 4B shows the beam overlap (410) when illumination is from a light emitter (418) above the sample plate (420), and FIG. 4C shows the beam overlap (410) when illumination is from a light emitter (422) below the sample plate (420). In one variation, when the cuvette is 0.7 mm in height, it may be useful to maintain the intersection (beam overlap) at a height of 0.35 mm in each cuvette of the plurality of cuvettes. The beam overlap may be manually adjusted, or automatically adjusted according to instructions from one or more processors.

Additionally, the method may include obtaining absorbance data (e.g., UV/Vis data) from the plurality of samples. For example, the plurality of samples may be illuminated with light having a wavelength ranging from about 190 nm to about 900 nm and absorbance measured. The absorbance data may be obtained using a module of the system, e.g., a second module as described above. The absorbance data may be obtained before or after light scattering data is obtained.

Characterization of particles may be accomplished on small sample volumes ranging from about 0.5 μl to about 2.5 μl, including all values and sub-ranges therein. For example, the sample volume may be about 0.1 μl, about 0.2 μl, about 0.3 μl, about 0.4 μl, about 0.5 μl, about 0.6 μl, about 0.7 μl, about 0.8 μl, about 0.9 μl, about 1.0 μl, about 1.1 μl, about 1.2 μl, about 1.3 μl, about 1.4 μl, about 1.5 μl, about 1.6 μl, about 1.7 μl, about 1.8 μl, about 1.9 μl, about 2.0 μl, about 2.1 μl, about 2.2 μl, about 2.3 μl, about 2.4 μl, or about 2.5 μl. In one variation, the volume of the plurality of samples is about 2 μl. In another variation, the volume of the plurality of samples is about 2 μl or less.

Determining the size of the one or more types of particles in the sample may be accomplished by one or more processors of the system configured to analyze data from the scattered light. The size of the one or more types of particles in the sample may range from about 0.3 nm to about 3,000 nm, including all values and sub-ranges therein. For example, the size of the one or more particles may be about 0.3 nm, about 0.4 nm, about 0.5 nm, about 0.6 nm, about 0.7 nm, about 0.8 nm, about 0.9 nm, about 1.0 nm, about 1.5 nm, about 2.0 nm, about 2.5 nm, about 3.0 nm, about 3.5 nm, about 4.0 nm, about 4.5 nm, about 5.0 nm, about 5.5 nm, about 6.0 nm, about 6.5 nm, about 7.0 nm, about 7.5 nm, about 8.0 nm, about 8.5 nm, about 9.0 nm, about 9.5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 1,000 nm, about 1,500 nm, about 2,000 nm, about 2,500 nm, or about 3,000 nm. The particles may include without limitation, nanoparticles, DNA, RNA, viruses, proteins, polymers, small molecules, and combinations thereof, as mentioned previously herein.

In some variations, data from light scattered at multiple (e.g., different) angles may be combined and analyzed by the one or more processors to determine a single result that may be angle independent. For example, the one or more processors may employ algorithms configured to determine particle size using data and/or signals relating to one or more of sample temperature, sample viscosity, hydrodynamic diameter of the particle, intensity of scattered light, ratio of the intensity of scattered light at a specific angle to incident light intensity, angle of scattered light, and rate of change of the intensity of scattered light (e.g., the fluctuation of the intensity of scattered light over time). In some variations, the one or more processors may comprise a correlator configured to analyze particles size based on the data and/or intensity of the various signals described above.

In some variations, once signals are obtained from scattered light detected by the single light detector at multiple scatter angles, the data from the light scattered at multiple (e.g., different) angles may then be combined and analyzed by the one or more processors to determine (e.g., used to calculate) a single result (e.g., single solution) that characterizes the particles in the samples (e.g., particle size and/or particle size distribution). The single solution may be angle independent. In one variation, determining the single solution includes satisfying all desired absolute correlation functions at once, the single solution being represented by the equation:

$${G}_{abs} ( q , χ ) = R ( q ) \cdot \sqrt{\vert {g}_{2} ( χ ) - 1 \vert}$$

wherein R(q) is the scatter intensity to Rayleigh ratio for each angle (Raleigh ratio at angle q), and the square root of the correlation function is multiplied by R(q). The correlation functions may be transformed, including adjustments for different scatter angles, temperatures, and viscosities (e.g., by rescaling the x-axis).

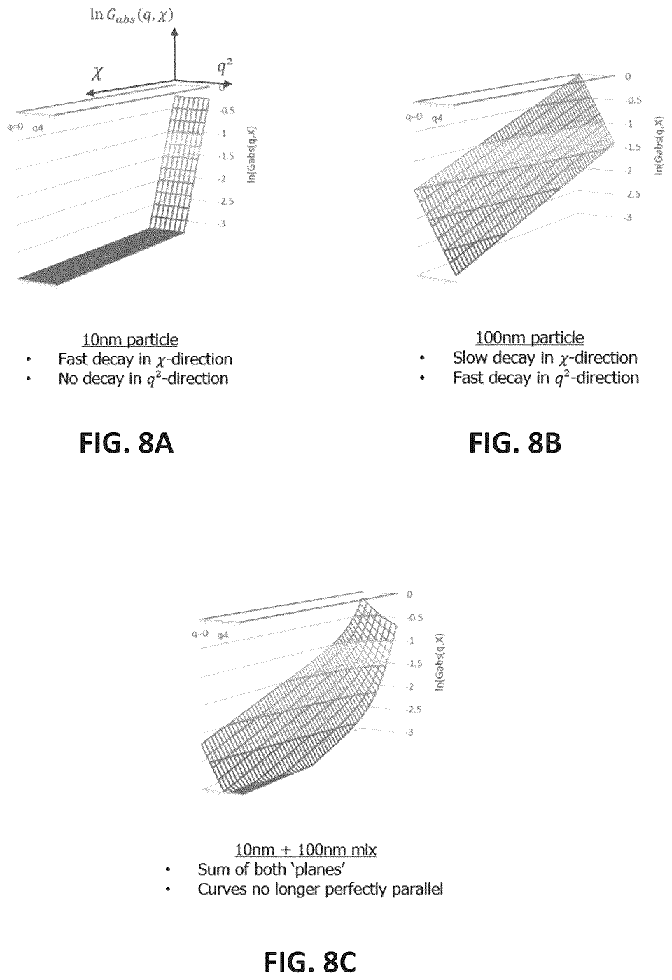

In some variations, the one or more processors may use the absolute correlation data obtained from light scattered at the plurality of angles to create a graphical representation, e.g., a 2D representation or model, of the absolute correlation functions. For a single particle, the 2D graphical representation may be a plane having a slope that tilts in the x and q² directions. Thus, for a mixture of particles, the 2D graphical representation may include a sum of such planes (e.g., planes are presented collectively). In one variation, the 2D representation may help determine the size of the one or more types of particles in each sample based on a shape of the absolute correlation function of the plurality of scatter angles collectively, as illustrated in FIGS. 8A-8C. For example, when the sample includes relatively smaller particles (e.g., 10 nm), the shape of the absolute correlation functions may be as shown in FIG. 8A, where all planes are parallel and there is fast decay in the x-direction and no decay in the q²-direction. When the sample includes relatively larger particles (e.g., 100 nm), the shape of the absolute correlation functions may be as shown in FIG. 8B, where all planes are also parallel, but the there is slow decay in the x-direction and fast decay in the q²-direction. When the sample includes a mixture of particles (e.g., 10 nm and 100 nm), the shape of the absolute correlation functions may be as shown in FIG. 8C, where the planes are not parallel and fan out in the x-direction.

Although the foregoing variations have, for the purposes of clarity and understanding, been described in some detail by illustration and example, it will be apparent that certain changes and modifications may be practiced, and are intended to fall within the scope of the appended claims. Additionally, it should be understood that the components and characteristics of the systems and devices described herein may be used in any combination. The description of certain elements or characteristics with respect to a specific figure are not intended to be limiting or nor should they be interpreted to suggest that the element cannot be used in combination with any of the other described elements. For all of the variations described herein, the steps of the methods may not be performed sequentially. Some steps are optional such that every step of the methods may not be performed.

1. A system for characterizing particles comprising:
one or more processors;
a plurality of samples, wherein each sample of the plurality of samples comprises one or more types of particles; and
a first module configured to measure light scattered by each sample, the first module comprising:
one or more light emitters;
an actuator having a rotation axis;
a single light detector configured to rotate about the rotation axis and receive light scattered by each sample at a plurality of scatter angles.

2. The system of claim 1, further comprising a sample plate configured to hold the plurality of samples.

3. The system of claim 2, wherein the sample plate comprises a plurality of cuvettes.

4. The system of claim 3, wherein the first module comprises one or more stage actuators configured to adjust a position of an emitting beam axis so that an intersection (beam overlap) between the emitting beam axis and a detector beam axis is restored in each sample when the light detector receives light scattered at each angle of the plurality of scatter angles.

5. (canceled)

6. The system of claim 4, wherein the one or more stage actuators is further configured to adjust a position of the first module so that that an intersection (beam overlap) between the emitting beam axis and the detector beam axis is maintained at the same height in the plurality of cuvettes.

7. The system of claim 2, further comprising a second module configured to automatically adjust the position of the sample plate according to instructions from the one or more processors.

8. The system of claim 1, wherein the single light detector comprises an optical fiber.

9. The system of claim 1, wherein the single light detector is configured to rotate from about 1.0 degree to about 280 degrees about the rotation axis.

10. The system of claim 1, wherein the single light detector is configured to receive forward light scattering from the plurality of scatter angles.

11. The system of claim 10, wherein the plurality of scatter angles ranges from about 25 degrees to about 45 degrees.

12. The system of claim 1, wherein the single light detector is configured to receive backward light scattering from the plurality of scatter angles.

13. The system of claim 12, wherein the plurality of scatter angles ranges from about 105 degrees to about 170 degrees.

14. The system of claim 1, further comprising a third module configured to illuminate the plurality of samples with light having a wavelength ranging from about 190 nm to about 900 nm, and measure an absorbance of the plurality of samples.

15. The system of claim 1, wherein the one or more light emitters comprises a laser light source.

16. The system of claim 1, wherein the one or more light emitters comprises a first light emitter and a second light emitter, and wherein the first light emitter is disposed above the sample plate, and the second light emitter is disposed below the sample plate.

17. (canceled)

18. The system of claim 1, wherein the one or more types of particles comprises a nanoparticle, DNA, RNA, a virus, a protein, a polymer, or a small molecule.

19. (canceled)

20. The system of claim 3, wherein the sample plate comprises one or more strip members having a length and a width, each strip member comprising a plurality of sample wells.

21. (canceled)

22. (canceled)

23. The system of claim 20, wherein each of the plurality of sample wells is coupled to a corresponding cuvette from the plurality of cuvettes by a channel.

24. The system of claim 3, wherein each cuvette of the plurality of cuvettes has a path length ranging from about 0.1 mm to about 0.7 mm.

25. (canceled)

26. (canceled)

27. The system of claim 1, wherein the one or more processors is configured to determine a size of the one or more types of particles in the sample.

28. The system of claim 27, wherein the size of the one or more types of particles in the sample ranges from about 0.3 nm to about 3,000 nm.

29. A system comprising:
a first module comprising a light detector configured to rotate above a sample plate containing a plurality of samples and detect scattered light from each sample at a plurality of scatter angles due to rotation thereof; and
a second module configured to measure absorbance of each sample of the plurality of samples,
wherein each sample of the plurality of samples comprises one or more types of particles.

30. The system of claim 29, further comprising one or more processors configured to determine a particle size or a particle size distribution from the scattered light detected at the plurality of scatter angles.

31. A method for characterizing particles comprising:
illuminating a plurality of samples with light from one or more light emitters, wherein each sample of the plurality of samples contains one or more types of particles;
rotating a light detector about a rotation axis over a plurality of scatter angles;
detecting light scattered by the particles over the plurality of scatter angles; and
obtaining a light scattering measurement for each scatter angle of the plurality of scatter angles.

32.-54. (canceled)
